(19) United States
(12) Patent Application Publication
(10) Pub. No.: US 2004/0151116 A1
(43) Pub. Date: Aug. 5, 2004

(54) Event based auto-link speed implementation in an information handling system network

(75) Inventors: Andrew Thomas Sultenfuss, Leander, TX (US); Christian L. Critz, Georgetown, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX

(21) Appl. No.: 10/356,066

(22) Filed: Jan. 31, 2003

(51) Int. Cl. H04J 3/14

(52) U.S. Cl. 370/232; 370/235

(57) ABSTRACT

A method for implementing an event-based auto-link speed implementation in an information handling system configurable to be part of a network is discussed. The event-based auto-link speed implementation includes detecting an event-based auto-link speed implementation issue in connection with the information handling system. Responsive to a detection, the system executes an auto line speed implementation routing for controlling a link speed of the information handling system network port. The information handling system includes a network port configured for being linked to a network port of another device in the network. The event-based auto-link speed implementation issue includes at least one selected from the group consisting of a thermal event-based issue and a power event-based issue. Lastly, responsive to a detection of an event-based auto-link speed implementation issue, the auto link speed implementation routine controls the information handling system network port to operate at a slowest available network port speed possible between the information handling system network port and the network port of the other device in the network, if enabled.

### BACKGROUND

The present disclosure relates generally to information handling systems, and more particularly to network device thermal management and automatic network port power management for information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In conjunction with information handling systems, thermal challenges within a notebook computer are becoming more and more of a concern as related design requirements call for adding higher power components to truly meet desktop replacement segments. In one related design requirement, notebook computers are moving to 10/100/1000 mb (Gigabit) networking solutions. Such a 10/100/1000 mb networking solution requires much higher power than needed in the past for a 10/100 networking solution. For example, the power at 1000 mb is approximately 1.3 W-2.6 W, depending upon the networking solution, compared to the power at 10/100 being approximately around 0.230 W-0.478 W.

FIG. 1 illustrates an example of a conventional networking link “auto” link speed selection implementation as relating to the IEEE 802.3 standard. As shown in FIG. 1, various system elements are coupled as part of a network 10. For example, a laptop (or notebook computer) 12 and a desktop (or workstation) 14 are networked via a first 10/100/1000 switch 16 to a second 10/100/1000 switch 18, and further to a remainder of the particular network at 20. In addition, server resources 22 are networked via the second 10/100/1000 switch 18 to the network 10. With respect to a conventional “auto” link speed implementation, the links 24 between the various system elements will “auto” to a highest speed possible between two connected devices for that particular portion of the network connection. Accordingly, the conventional “auto” link speed implementation chooses a fastest speed available, while ignoring thermal issues.

In addition to thermal considerations, power consumption also has a distinct impact on information handling systems, and in particular, with respect to mobile designs. Networking devices/ports represent an element of this power consumption. Networking devices by their nature are targeted for an “always on” approach, representing a constant drain on power. With the increases in speed and complexity, networking ports represent growing power consumption in both active and stand-by conditions. Current power consumption regulation methods operate to turn off a device port or simply allow the device port to bear the burden of power consumption (i.e., use the port as is with attendant power issues).

Further in connection with network solutions, networking standards view speed as the critical factor when negotiating a link session. This is true for both wired and wireless forms of auto-negotiation. Ethernet, in particular, uses an approach to automatically start at the highest speed available (N-way). This sets the port (and network partner) for the highest consumption rate. Mobile, desktop, server, as well as, network infrastructure ports are impacted by this power consumption. That is, all must communicate with each other at the link speed.

Improvements in client network power consumption are desired to provide wide and continued power savings. A need exists for managed network power consumption.

Accordingly, it would be desirable to provide an network solution for overcoming the problems in the art as discussed above.

### SUMMARY

According to one embodiment, a method for implementing an event-based auto-link speed implementation in an information handling system configurable to be part of a network is disclosed. The event-based auto-link speed implementation includes detecting an event-based auto-link speed implementation issue in connection with the information handling system. Responsive to a detection, the method executes an auto line speed implementation routing for controlling a link speed of the information handling system network port. The information handling system includes a network port configured for being linked to a network port of another device in the network. The event-based auto-link speed implementation issue includes at least one selected from the group consisting of a thermal event-based issue and a power event-based issue. Lastly, responsive to a detection of an event-based auto-link speed implementation issue, the auto link speed implementation routine controls the information handling system network port to operate at a slowest available network port speed possible between the information handling system network port and the network port of the other device in the network, if enabled.

### BRIEF DESCRIPTION OF THE DRAWINGS

FIG. 1 illustrates a conventional networking link “auto” link speed selection implementation;

FIG. 2 illustrates a block diagram view of an information handling system according to an embodiment of the present disclosure;

FIG. 3 illustrates a thermal event based “auto” link speed selection implementation according to an embodiment of the present disclosure;

FIG. 4 illustrates a network port implementation of thermal event based link speed selection control according to another embodiment of the present disclosure;

FIG. 5 illustrates a power event based “auto” link speed selection implementation according to an embodiment of the present disclosure; and

FIG. 6 illustrates a network port implementation of power based link speed selection control according to another embodiment of the present disclosures.

### DETAILED DESCRIPTION

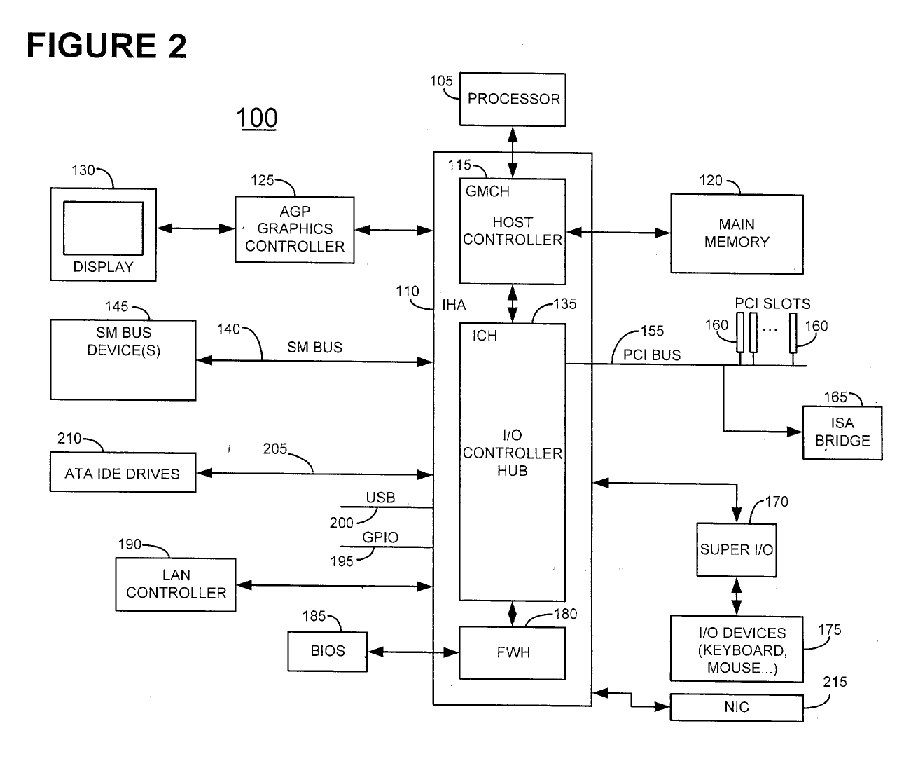

FIG. 2 depicts a high level block diagram of an information handling system 100 in which the disclosed technology is practiced. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The particular information handling system 100 depicted in FIG. 2 is a portable computer which includes a processor 105. An Intel Hub Architecture (IHA) chip 110 provides system 100 with memory and I/O functions. More particularly, IHA chip 110 includes a Graphics and AGP Memory Controller Hub (GMCH) 115. GMCH 115 acts as a host controller that communicates with processor 105 and further acts as a controller for main memory 120. GMCH 115 also provides an interface to Advanced Graphics Port (AGP) controller 125 which is coupled thereto. A display 130 is coupled to AGP controller 125. IHA chip 110 further includes an I/O Controller Hub (ICH) 135 which performs numerous I/O functions. ICH 135 is coupled to a System Management Bus (SM Bus) 140 which is coupled to one or more SM Bus devices 145.

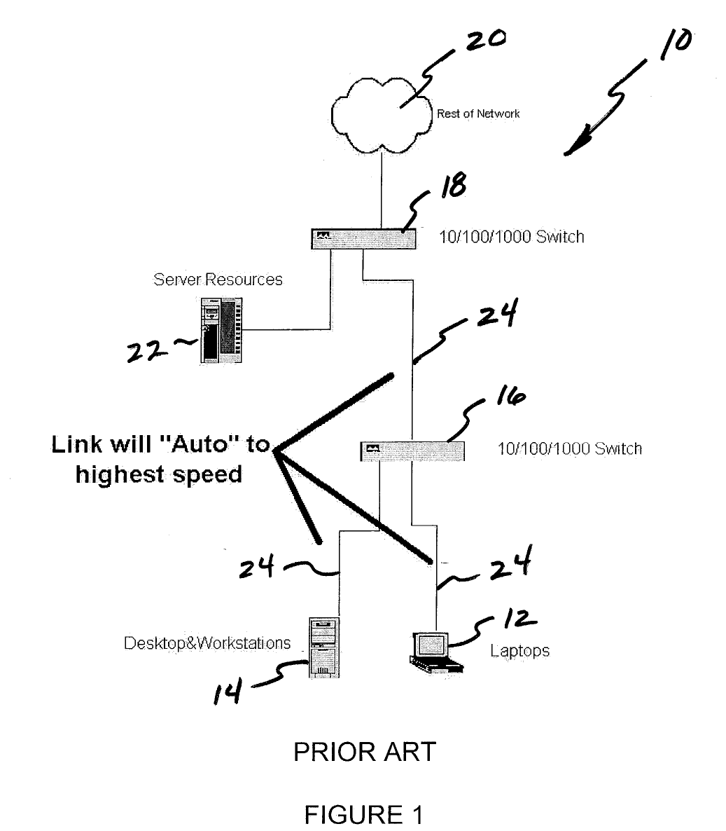

ICH 135 is coupled to a Peripheral Component Interconnect (PCI) bus 155 which is coupled to mini PCI connector slots 160 which provide expansion capability to portable computer 100. A super I/O controller 170 is coupled to ICH 135 to provide connectivity to input devices such as a keyboard and mouse 175 as shown in FIG. 1. A firmware hub (FWH) 180 is coupled to ICH 135 to provide an interface to system BIOS 185 which is coupled to FWH 180. A General Purpose I/O (GPIO) bus 195 is coupled to ICH 135. USB ports 200 are coupled to ICH 135 as shown. USB devices such as printers, scanners, joysticks, etc. can be added to the system configuration on this bus. An integrated drive electronics (IDE) bus 205 is coupled to ICH 135 to connect IDE drives 210 to the computer system. Note also that the LAN port can exist on the memory access controller (MAC) of the ICH or be a discrete device located on another bus (e.g. PCI). Furthermore, a network interface card 215 provides a network port for coupling system 100 to a network, as discussed herein. System 100 may further include a PCI adapter, as well as a MAC/PHY of the ICH 135.

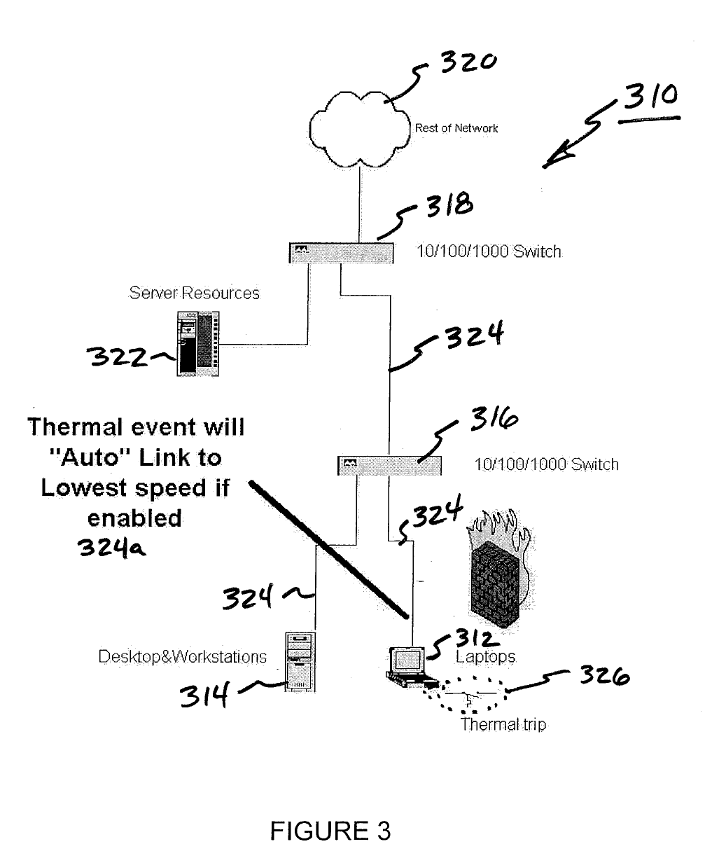

FIG. 3 illustrates a networking “auto” link speed selection implementation according to one embodiment of the present disclosure. As shown in FIG. 3, various system elements are coupled as part of a network 310, further for use in the thermal event based “auto” link speed selection control of the present disclosure. For example, a laptop (or notebook computer) 312 and a desktop (or workstation) 314 are networked via a first 10/100/1000 switch 316 to a second 10/100/1000 switch 318, and further to a remainder of the particular network at 320. In addition, server resources 322 are networked via the second 10/100/1000 switch 318 to the network 310. With respect to the “auto” link speed implementation according to one embodiment of the present disclosure, the links 324 between the affected system elements (i.e., the elements impacted by the thermal event(s)) will “auto” to a lowest speed possible between the respective affected devices of the network connection in response to detection of a thermal event or events. Accordingly, the thermal event based “auto” link speed implementation chooses a slowest speed available, in response to detection of thermal issues, further as discussed herein.

According to one embodiment, the laptop 312 includes a means 326 for providing a thermal trip. Responsive to a thermal event activation of the thermal trip 326, the “auto” link speed implementation method according to one embodiment of the present disclosure controls the link 324 to a lowest speed possible between the two connected devices 312 and 316, for that particular portion of the network connection at 324a.

According to one embodiment of the present disclosure, a method for implementing network device thermal management includes providing thermal instrumentation in one or more of a network port, chip, or system. For example, the thermal instrumentation 326 may include one or more of an internal thermistor, an external thermistor, or a similar thermal measurement/trip device.

Upon an occurrence of a thermal event and its detection by the thermal instrumentation, the method for implementing network device thermal management includes triggering a reverse N-way auto speed cycle on detection of the thermal event (if enabled). “Reverse N-way” refers to an automatic slowest speed selection process.

In one embodiment, the speed of the reverse N-way auto speed cycle is selected to be the speed of the lowest working state of network devices linked between one another and for implementing a lowest thermal mode.

The method for implementing network device thermal management includes implementing the reverse N-way auto speed cycle by alerting the network instrumentation of the same. More particularly, in response to a detection of an occurrence of a thermal event, the thermal event affected network port alerts the network management (if enabled) that a thermal event has occurred. In one embodiment, the network port alerts the network instrumentation via a network alert message using alerts standard forum (ASF) and/or simple network management protocol (SNMP). SNMP includes a set of protocols for managing complex networks. SNMP works by sending messages, referred to as protocol data units (PDUs), to different parts of a network. SNMP compliant devices, called agents, store data about themselves in management information bases (MIBs) and return this data to the SNMP requesters.

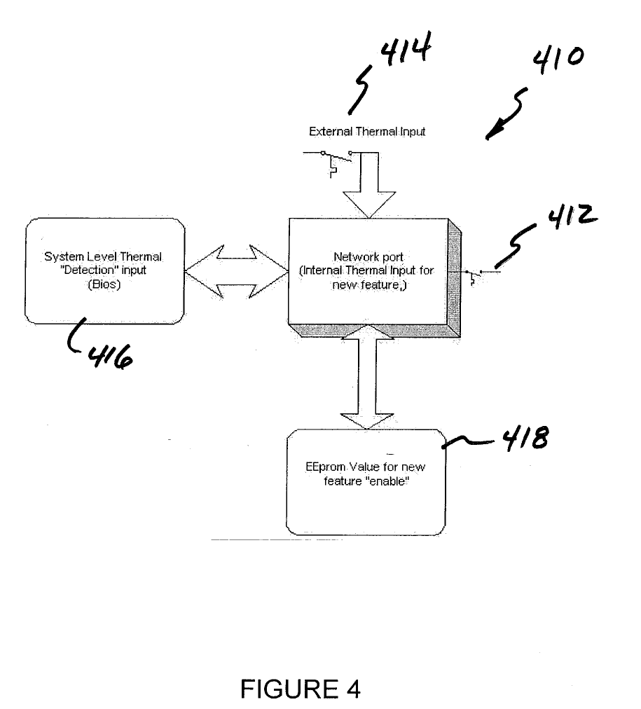

FIG. 4 illustrates an implementation of a network port 410 for use in a thermal event based link speed selection control according to one embodiment of the present disclosure. More particularly, network port 410 includes an internal thermal input 412 for implementing the thermal based link speed control of the present disclosure similarly as discussed herein above. Additional inputs include an external thermal input 414, a system level thermal “detection” input 416 (e.g., implemented in a system BIOS of a network port), and an EEPROM value 418 for use in enabling the thermal based link speed control feature (i.e., the thermal based link speed control feature “enable” stored in an EEPROM of a network port). Note that while value 418 has been discussed as an EEPROM value, it may also be a value stored in other types of storage, to include, but not be limited to: Serial Flash, PROM/ROM, Flash, BIOS, FWH, and the like.

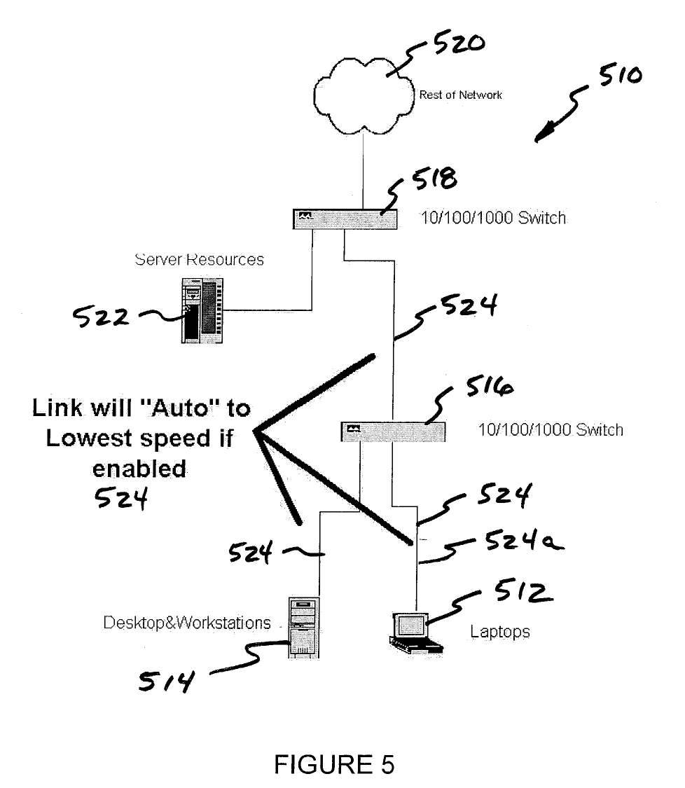

FIG. 5 illustrates a networking “auto” link speed selection implementation according to another embodiment of the present disclosure. As shown in FIG. 5, various system elements are coupled as part of a network 510, further for use in the power event based “auto” link speed selection control of the present disclosure. For example, a laptop (or notebook computer) 512 and a desktop (or workstation) 514 are networked via a first 10/100/1000 switch 516 to a second 10/100/1000 switch 518, and further to a remainder of the particular network at 520. In addition, server resources 522 are networked via the second 10/100/1000 switch 518 to the network is 510. With respect to a the “auto” link speed implementation according to one embodiment of the present disclosure, the links 524 between the affected system elements (i.e., the elements impacted by the power oriented event(s)) will “auto” to a lowest speed possible between the respective affected devices of the network connection in response to detection of a power oriented event or events. Accordingly, the power oriented event based “auto” link speed implementation chooses a slowest speed available, in response to detection of prescribed power issues, further as discussed herein.

According to one embodiment, the laptop 512 includes a means 526 for providing a power consumption trip. Responsive to a power oriented event activation of the power consumption trip 526, the “auto” link speed implementation method according to one embodiment of the present disclosure controls the link 524 to a lowest speed possible between the two connected devices 512 and 516, for that particular portion of the network connection at 524a.

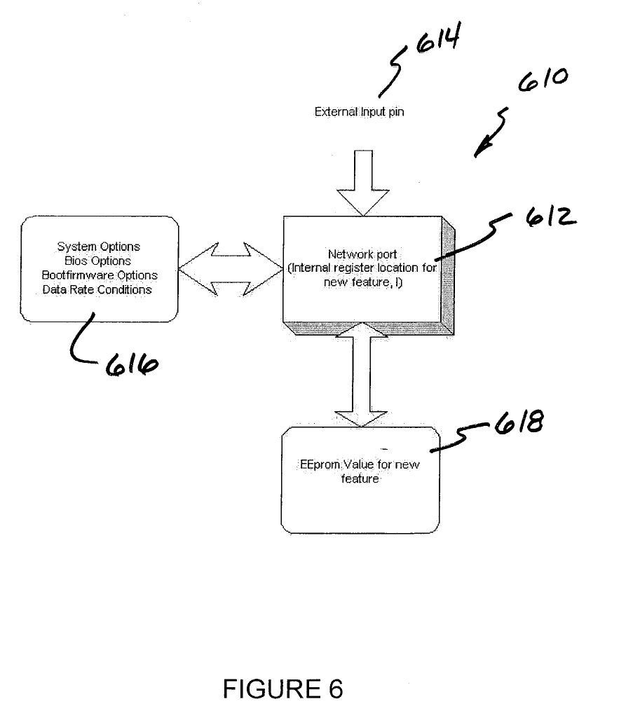

FIG. 6 illustrates an implementation of a network port 610 for use in a power event based “auto” link speed selection control according to one embodiment of the present disclosure. More particularly, network port 610 includes an internal register location 612 for the power event feature for implementing the power event based “auto” link speed control of the present disclosure, similarly as discussed herein above. Additional inputs include one or more of an external power event input pin 614, a system level power event “detection” system input 616, and an EEPROM value 618 for use in enabling the power event based link speed control feature (i.e., the power event based link speed control feature “enable” stored in an EEPROM of a network port). With respect to the system level power event “detection” system input 616, such an input can be implemented in one or more of the following: as a system option of a network port, as a system BIOS option of a network port, as a boot firmware option of a network port, and as a function of data rate conditions at the network port. Note that while value 618 has been discussed as an EEPROM value, it may also be a value stored in other types of storage, to include, but not be limited to: Serial Flash, PROM/ROM, Flash, BIOS, FWH, and the like.

In particular, according to one embodiment, the method includes modifying the networking port to invert the “auto” speed selection scheme, such that the lowest negotiated link speed is chosen based upon a system control element. In this embodiment, the system control element is configured to change the advertised speed capability, using one or more of: an input pin on a local area network (LAN) controller, a LAN EEPROM value, a configuration register setting, or a physical (PHY) register setting.

In another embodiment, the method considers the port behavior based on power, such as, by AC, battery, or user profile (in a manner similar to a notebook computer power management). If the networking port is operating on battery power, then the system negotiates the lowest speed link. For AC power, the method targets the highest negotiated link (similar to a conventional “Auto” N-way). The method could also take advantage of a user profile, such as, the user profile indicating preference for a given condition (e.g., Normal, Performance, or Power Save under AC or DC states). Accordingly, the method operates to conserve power, maximize performance and offer user options as may be needed for a particular networking implementation.

In yet another embodiment, the method integrates the inverted speed option into a system power option settings (e.g., profiles, power properties, etc.) used in BIOS and by the operating system (OS) of a respective network port device.

Accordingly, this embodiment allows a user interface to include simple power optimized options while maintaining automatic link networking principles.

In still yet another advanced embodiment, the method utilizes data flow indicators to up-shift/down-shift the power event based “auto” link speed control of the present disclosure. In other words, the method utilized data flow indicators to up-shift and/or down-shift the power event based “auto” link speed control as needed to maximize performance as a function of both power and performance.

Although only a few exemplary embodiments have been described in detail above, those skilled in the art will readily appreciate that many modifications are possible in the exemplary embodiments without materially departing from the novel teachings and advantages of the embodiments of the present disclosure. For example, while the embodiments have been discussed with reference to notebook computers, the aspects of the embodiments of the embodiments of the present disclosure can and do apply to desktop applications as well. Furthermore, switches can also benefit from the aspects of the embodiments as well, for example, via an embedded engine. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system configurable to be part of a network, comprising:
a processor;
a memory;
a network port configured for being linked to a network port of another device in the network;
means for detecting an event-based auto-link speed implementation issue, the event-based auto-link speed implementation issue including at least one selected from the group consisting of a thermal event-based issue and a power event-based issue; and
an auto link speed implementation routine stored in said memory and executable by said processor for controlling a link speed of said network port, wherein responsive to a detection of an event-based auto-link speed implementation issue by said detecting means, said auto link speed implementation routine controls said network port to operate at a slowest available network port speed possible between said network port and the network port of the other device in the network, if enabled.

2. The system of claim 1, wherein the event-based auto-link speed implementation issue includes a thermal event-based issue, further wherein said detection means includes thermal instrumentation configured to provide a thermal input via at least one selected from the group consisting of an internal thermal input, an external thermal input, a system level thermal detection input, and a stored enable thermal input value.

3. The system of claim 2, wherein the system level thermal detection input is implemented in a system BIOS.

4. The system of claim 2, wherein the thermal instrumentation includes at least one selected from the group consisting of an internal thermistor, an external thermistor, and a thermal measurement/trip device.

5. The system of claim 1, wherein operating at a slowest available network port speed includes triggering a reverse N-way auto speed cycle.

6. The system of claim 5, wherein the reverse N-way auto speed cycle operates at a lowest possible working state of said network ports linked between one another.

7. The system of claim 6, further wherein the reverse N-way auto speed cycle further implements a low thermal mode.

8. The system of claim 5, wherein said routine implements the reverse N-way auto speed cycle by alerting network instrumentation of the same, if enabled.

9. The system of claim 8, wherein alerting network instrumentation includes sending a network alert message across the network via said network port, the network alert message including a message in a format of at least one selected from the group consisting of an alerts standard forum (ASF) message and a simple network management protocol (SNMP) message.

10. The system of claim 1, wherein the event-based auto-link speed implementation issue includes a power event-based issue, further wherein said detection means includes power instrumentation configured to provide a power input via at least one selected from the group consisting of an internal power input, an external power input, a system level power detection input, and a stored enable power input value.

11. The system of claim 10, wherein the system level power detection input is implemented in a system BIOS.

12. The system of claim 10, wherein the power instrumentation includes at least one selected from the group consisting of an internal power event register location, an external power event input pin, a system level power event detection system input, and a stored value for use in enabling the power event based link speed control feature.

13. The system of claim 12, wherein the system level power event detection system input is implemented in at least one selected from the group consisting of a system option of a network port, a system BIOS option of a network port, a boot firmware option of a network port, and a function of data rate conditions at said network port.

14. The system of claim 13, wherein the system level power event detection system input is a function of port behavior based upon power, the power including at least one selected from the group consisting of AC power, battery power, and user profile.

15. The system of claim 13, wherein the system level power event detection system input is a function of data rate conditions at said network port, and wherein controlling the link speed of said network port includes utilizing data flow indicators of the data rate conditions to up-shift/down-shift link speed in response to the system level power event detection system input, if enabled.

16. The system of claim 10, wherein controlling the link speed of said network port includes implementing control of an inverted auto speed cycle to a lowest negotiated link speed in response to a system control element, if enabled.

17. The system of claim 16, further wherein the system control element changes an advertised speed capability with the use of at least one selected from the group consisting of an input pin on a local area network (LAN) controller, a LAN stored value, a configuration register setting, or a physical (PHY) register setting.

18. The system of claim 16, wherein the inverted auto speed cycle includes a system power option setting used in BIOS and by an operating system of said information handling system.

19. A method for implementing an event-based auto-link speed implementation in information handling system configurable to be part of a network, comprising:
detecting an event-based auto-link speed implementation issue in connection with the information handling system, the information handling system including a network port configured for being linked to a network port of another device in the network, the event-based auto-link speed implementation issue including at least one selected from the group consisting of a thermal event-based issue and a power event-based issue; and
executing an auto link speed implementation routine for controlling a link speed of the information handling system network port, wherein responsive to a detection of an event-based auto-link speed implementation issue, the auto link speed implementation routine controls the information handling system network port to operate at a slowest available network port speed possible between the information handling system network port and the network port of the other device in the network, if enabled.

20. The method of claim 19, wherein the event-based auto-link speed implementation issue includes a thermal event-based issue, further wherein the detection includes using thermal instrumentation configured to provide a thermal input via at least one selected from the group consisting of an internal thermal input, an external thermal input, a system level thermal detection input, and a stored enable thermal input value.

21. The method of claim 20, further including implementing the system level thermal detection input in a system BIOS.

22. The method of claim 20, wherein the thermal instrumentation includes at least one selected from the group consisting of an internal thermistor, an external thermistor, and a thermal measurement/trip device.

23. The method of claim 19, wherein operating at a slowest available network port speed includes triggering a reverse N-way auto speed cycle.

24. The method of claim 23, wherein the reverse N-way auto speed cycle operates at a lowest possible working state of the network ports linked between one another.

25. The method of claim 24, further wherein the reverse N-way auto speed cycle further implements a low thermal mode.

26. The method of claim 23, wherein the routine implements the reverse N-way auto speed cycle by alerting network instrumentation of the same, if enabled.

27. The method of claim 26, wherein alerting network instrumentation includes sending a network alert message across the network via the network port, the network alert message including a message in a format of at least one selected from the group consisting of an alerts standard forum (ASF) message and a simple network management protocol (SNMP) message.

28. The method of claim 19, wherein the event-based auto-link speed implementation issue includes a power event-based issue, further wherein the detection includes using power instrumentation configured to provide a power input via at least one selected from the group consisting of an internal power input, an external power input, a system level power detection input, and a stored enable power input value.

29. The method of claim 28, further including implementing the system level power detection input in a system BIOS.

30. The method of claim 28, wherein the power instrumentation includes at least one selected from the group consisting of an internal power event register location, an external power event input pin, a system level power event detection system input, and a stored value for use in enabling the power event based link speed control feature.

31. The method of claim 30, further including implementing the system level power event detection system input in at least one selected from the group consisting of a system option of a network port, a system BIOS option of a network port, a boot firmware option of a network port, and a function of data rate conditions at the network port.

32. The method of claim 31, wherein the system level power event detection system input is a function of port behavior based upon power, the power including at least one selected from the group consisting of AC power, battery power, and user profile.

33. The method of claim 31, wherein the system level power event detection system input is a function of data rate conditions at said network port, and wherein controlling the link speed of said network port includes utilizing data flow indicators of the data rate conditions to up-shift/down-shift link speed in response to the system level power event detection system input, if enabled.

34. The method of claim 28, wherein controlling the link speed of the network port includes implementing control of an inverted auto speed cycle to a lowest negotiated link speed in response to a system control element, if enabled.

35. The method of claim 34, further wherein the system control element changes an advertised speed capability with the use of at least one selected from the group consisting of an input pin on a local area network (LAN) controller, a LAN stored value, a configuration register setting, or a physical (PHY) register setting.

36. The method of claim 34, wherein the inverted auto speed cycle includes a system power option setting used in BIOS and by an operating system of said information handling system.
